(19) United States
(12) Patent Application Publication
(10) Pub. No.: US 2007/0051167 A1
(43) Pub. Date: Mar. 8, 2007

(54) Universal testing tool for commercial and/or residential gas systems

(76) Inventor: Mickey W. Finley, Midland, TX (US)

Correspondence Address: THE LAW FIRM OF HARRIS & BURDICK;HAROLD BURDICK AND ROBERT HARRIS, 6676 GUNPARK DRIVE, SUITE E, BOULDER, CO, 80301, US

(21) Appl. No.: 11/221,291

(22) Filed: Sep. 8, 2005

(51) Int. Cl. G01M 3/02; F16L 55/07

(52) U.S. Cl. 73/40.5 R; 285/93

(57) ABSTRACT

A universal testing tool is disclosed for accommodating gas system pressurization and leak detection. The tool includes a manifold body for interconnection of and fluid communication between one of several system adapters, a pressure gauge, a fluid intake stem, and a pressure relief valve. The system adapters are utilized for changing configurations of the tool to adapt to different system leads, each including a hand manipulable central body portion between a size/configuration standardized threaded tool mounting end and a variously configured threaded system adaptation end.

### FIELD OF THE INVENTION

This invention relates to closed system pressurizing test tools, and, more particularly, relates to commercial and residential gas supply system leak detection tools.

### BACKGROUND OF THE INVENTION

Heretofore, extensive replumbing has been required in order to test the integrity of a commercial or residential gas supply system (supplying and routing natural gas, liquefied propane and the like, and including the facility's piping and connections to various appliances utilizing the system). Typically, leak testing in such systems has required disconnection of the gas company's meter (of other facility lead) from the customer's side of the gas supply, removal of the threaded steel fittings (a swivel union, for example) from the system input (the customer side of a meter body, for example), and adaptation of other fittings to allow installation of the pressure gauging test tool on the system input piping. The adaptation process is time consuming, often involving repeated trial and error attempts to establish the proper connections. Once in place, the usual process for testing the system may proceed (system pressurization from a pressurized fluid source introduced through yet another fitting into the system to test for system gas pressure stability).

The difficulties heretofore encountered have been largely due to the fact that there are no standard dimensions for the threaded fitting that typically connects a meter or other lead to the facility piping. To accommodate the various sizes and/or configurations encountered, the test technician must carry a variety of fittings to allow test tool adaptation and the addition of an air intake stem. This process adds unnecessary time to the testing process (both adding to the expense and potentially prolonging a dangerous situation if a leak is present).

Gas pressure testing tools for facility gas systems have been heretofore suggested and/or utilized (see, U.S. Pat. Nos. 6,719,002, 6,279,608, 3,756,072 and 2,727,383). Leak test tools for liquid circulation systems have also been heretofore suggested and/or utilized (see U.S. Pat. No. 5,105,653), at least one including a stepped rubber plug for adapting to various sizes of system orifices (see U.S. Pat. No. 6,675,829 directed to a tool attachable to an automobile radiator). None of these heretofore known tools for pressurizing a fluid circulation system for leak detection have, however, addressed the difficulties inherent where testing of system integrity requires relatively high pressurization of a sealed system carrying corrosive materials such as natural gas or propane, and where the attachment locale has a threaded fitting thereat which could be any of a large variety of dimensions and characterized by a variety of thread configurations, sizes, spacing, pitches or the like. Further improvement could thus be utilized in the field of test tools for facility gas supply systems.

### SUMMARY OF THE INVENTION

This invention provides a tool for accommodating pressurization of a facility gas supply system at system piping to test system integrity, and a gas system adapter set for such a tool thereby making the tool more universally adaptable to various systems. The tool is used to pressurize a commercial or residential gas supply system to detect system leaks, the adapter set utilized to adapt the detecting tool for connection at threaded fittings of various sizes, orientations or configurations that connect the systems to system meters or other supplier leads. The tool and adapters of this invention are configured for relatively high pressure operation in association with sealed systems carrying corrosive materials such as natural gas or liquefied propane, and are quickly and simply adaptable at attachment locales having threaded system access fittings which could be any of a large variety of dimensions and/or be characterized by a variety of orientations, thread sizes, spacing, pitches or the like.

The tool includes a manifold body having a plurality of access openings in fluid communication with one another, one of the openings adapted for connection with a pressurized fluid source. A gauge having a stem (preferably threaded) is engageable at another of the access openings, and plural interchangeable threaded system adapters are selectively engageable at still another of the access openings.

A valved fluid intake stem is preferably threadably engageable at the first access opening and a pressure relief valve is preferably threadably engageable at yet another access opening. The plural adapters each include a manipulable (preferably manually) central body portion between a size/configuration standardized threaded tool mounting end engageable at the manifold body and a variously configured threaded system adaptation end.

The gas system adapter set includes a first adapter having the central body portion between the tool mounting end and a selectively configured threaded system adaptation end. At least one additional adapter is provided which also includes the central body portion between the tool mounting end and a selectively configured threaded system adaptation end. The adapters' tool mounting ends are all of substantially the same size and configuration while the selectively configured threaded system adaptation ends thereof are differently configured.

It is therefore an object of this invention to provide an improved tool accommodating pressurization of a facility gas supply system at system piping to test system integrity.

It is another object of this invention to provide a tool accommodating pressurization of a facility gas supply system at system piping to test system integrity and a system adapter set that are configured for relatively high pressure operation in association with sealed systems carrying corrosive materials such as natural gas or liquefied propane.

It is another object of this invention to provide a tool accommodating pressurization of a facility gas supply system at system piping to test system integrity and a system adapter set that are quickly and simply adaptable at attachment locales having threaded system access fittings which could be any of a large variety of dimensions and/or be characterized by a variety of orientations, thread sizes, spacing, pitches or the like.

It is still another object of this invention to provide a gas system adapter set for adapting a leak detecting tool used to pressurize a commercial and/or residential gas supply system to allow connection at threaded system inlet fittings of various sizes, orientations and/or configurations.

It is yet another object of this invention to provide a universal leak detection tool for testing pressurization stability at commercial and/or residential gas supply system piping.

It is another object of this invention to provide a tool for accommodating pressurization of a facility gas supply system at system piping to test system integrity including a manifold body having a plurality of access openings in fluid communication with one another, one of the openings adapted for connection with a pressurized fluid source, a gauge having a stem engageable at another of the access openings of the manifold body, and plural interchangeable threaded system adapters selectively engageable at still another of the access openings.

It is still another object of this invention to provide a gas system adapter set for a leak detecting tool used to pressurize a commercial or residential gas supply system, the adapter set utilized to adapt the detecting tool for connection at threaded fittings of various sizes, orientations and/or configurations that connect facility gas systems to system leads, the adapter set including a first adapter including a central body portion between a tool mounting end and a selectively configured threaded system adaptation end, and at least one additional adapter including a central body portion between a tool mounting end of substantially the same size and configuration as the tool mounting end of the first adapter and a selectively configured threaded system adaptation end differently configured from the selectively configured threaded system adaptation end of the first adapter.

It is yet another object of this invention to provide a universal leak detection tool for testing pressurization stability at commercial and/or residential gas supply system piping that includes a manifold body having at least first, second, third and forth threaded access openings in fluid communication with one another, a valved fluid intake stem threadably engageable at the first access opening, a pressure relief valve threadably engageable at the second access opening, a pressure gauge having a threaded stem engageable at the third access opening, and a plurality of adapters each including a manipulable central body portion between a size/configuration standardized threaded tool mounting end engageable at the forth access opening and a variously configured threaded system adaptation end.

With these and other objects in view, which will become apparent to one skilled in the art as the description proceeds, this invention resides in the novel construction, combination, and arrangement of parts substantially as hereinafter described, and more particularly defined by the appended claims, it being understood that changes in the precise embodiment of the herein disclosed invention are meant to be included as come within the scope of the claims.

### BRIEF DESCRIPTION OF THE DRAWINGS

The accompanying drawings illustrate a complete embodiment of the invention according to the best mode so far devised for the practical application of the principles thereof, and in which:

FIG. 1 is a perspective view of a testing tool in accord with this invention utilizing a first selected system adapter;

FIG. 2 is an exploded view of the testing tool of this invention showing several interchangeable system adapters (three are shown, though the number, variety and characteristics of the adapters which may be provided are limited only by the likely circumstances that may be encountered at a testing site);

FIG. 3 is a sectional view of the manifold body of the testing tool of this invention; and

FIG. 4 is a sectional view of one of the system adapters of the testing tool of this invention.

### DESCRIPTION OF THE INVENTION

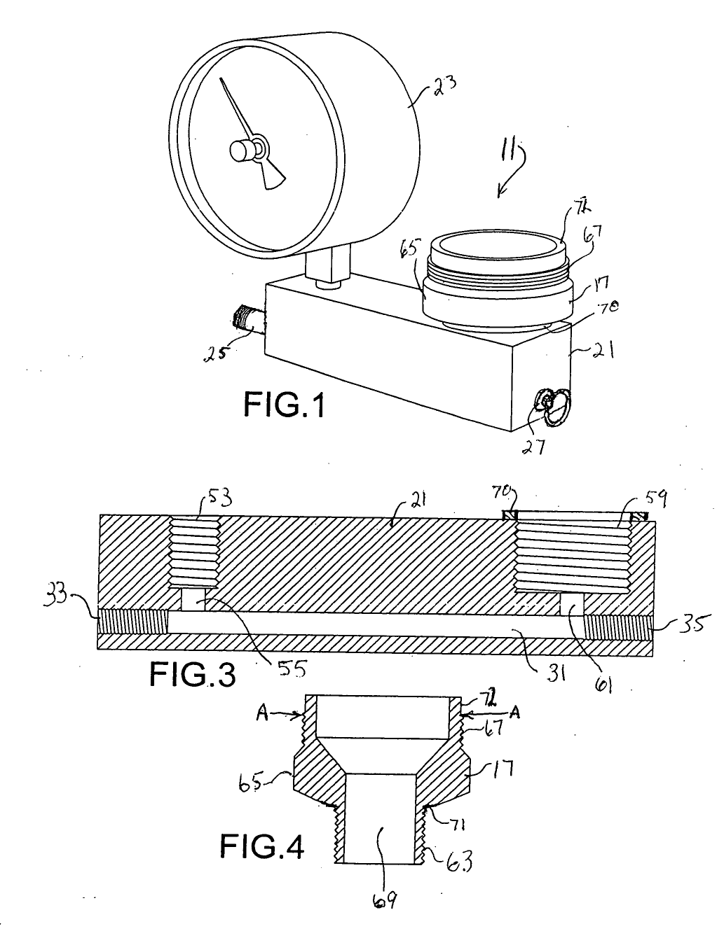

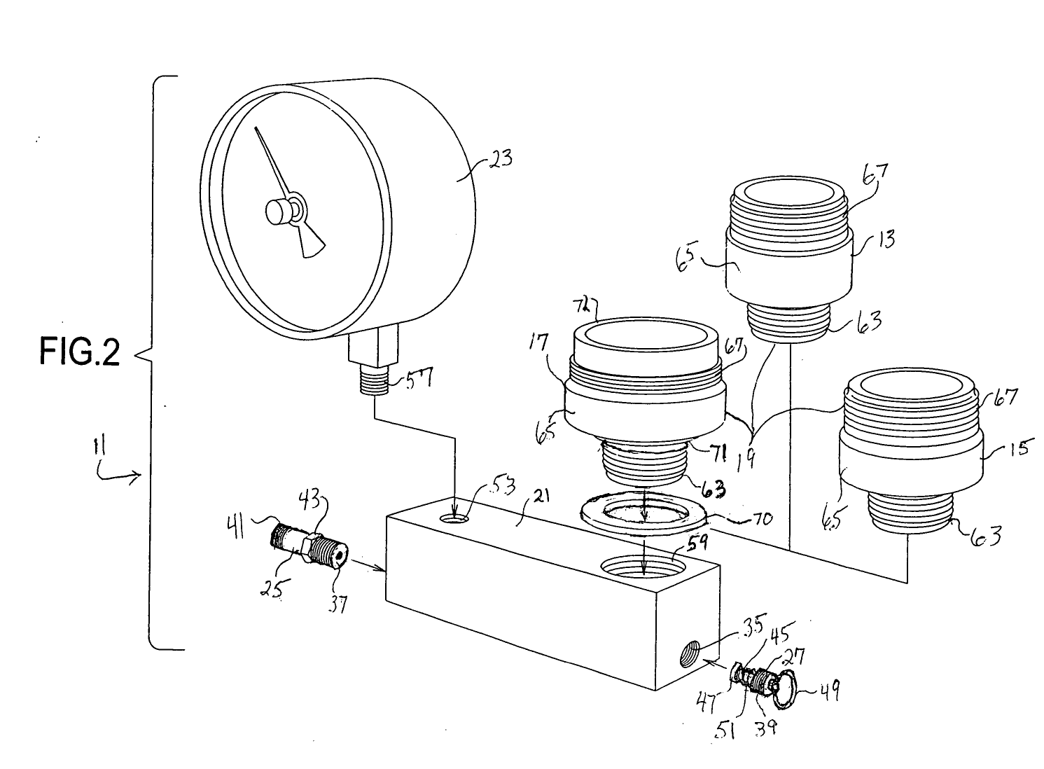

A single configuration of the universal testing tool 11 of this invention is illustrated in FIG. 1, while several of the system adapters 13, 15 and 17 utilized for changing configurations of the tool are illustrated by FIG. 2 (showing one aggregation of adapters in an adapter set 19, unlimited different aggregations of adapters of different sizes, orientations and characteristics being possible). Testing tool 11 is utilized for pressurizing a facility gas supply system when attached to a source of pressurized air and to the threaded fitting connecting the system meter or other system lead to the system gas piping (typically a swivel union, utilization of which in system construction to connect meters or other leads with facility piping is well known). Monitoring pressure stability of the system after pressurization enables the technician to detect system leaks or other integrity failures.

In addition to the adapters, testing tool 11 includes manifold body 21 for interconnection of and fluid communication between one of the adapters 13/15/17 (adapter 17 is shown connected therewith in FIG. 1), pressure gauge 23, fluid intake stem 25 and pressure relief valve 27. Manifold body 21 may be of any size or shape suited to the particular application, and as shown in FIG. 3 includes fluid communication passageway 31 therethrough between threaded access openings 33 and 35 (female threaded openings). Access opening 33 receives the first threaded end 37 of valved stem 25 therein and access opening 35 receives the male threaded valve body 39 of relief valve 27.

Stem 25 may be any known and commercially available stem valve or the like utilized for one way passage of fluid (for example, air) therethrough. Preferably, such valve is provided with second threaded end 41 for engagement by a threaded nozzle of a pressurized air supply. Wrench engagable nut configuration 43 is formed at the body to facilitate fluid tight mounting in manifold body 21. Relief valve 27 is of common configuration and is rated, for example, at about 8 pounds (to valve release). Valve 27 includes relief plunger 45 having seat 47 at one end and manual relief actuating ring 49 at the other. Spring 51 is calibrated to provide the appropriate relief rating.

Threaded mounting opening 53 in manifold body 21 is in communication through lateral passage 55 with passageway 31. Opening 53 receives threaded inlet stem 57 of pressure gauge 23 (a standard gauge capable of fluid tight mounting for measuring fluid pressure in inches of mercury or pounds per square inch, as is known in the field, can be utilized). Threaded opening 59 in manifold body 21 communicates through lateral passage 61 with passageway 31. Opening 59 receives size/configuration standardized threaded tool mounting end 63 of any of the hand mountable adapters of this invention (adapters 13, 15 or 17 of set 19, for example).

The adapters of this invention are made of metal impervious to the corroding effects of natural gas or liquefied propane, and each include a hand manipulable, preferably annular, central body portion 65 between standardized threaded tool mounting end 63 and variously configured threaded system adaptation end 67 having an outside diameter (dimension A in FIG. 4). Communication passageway 69 run concentrically through each adapter (see FIG. 4). To facilitate leakage sealing with only hand tightening of the adapters at the manifold body, a rubber gasket 70 receives mounting end 63 therethrough and seats between the flat bottom 71 of body portion 65 and the top of manifold body 21. The inside diameter of gasket 70 is about equal to the diameter of opening 59. Other characteristics may be utilized as appropriate for a give desired system adaptation (unthreaded annular upper ring 71 on adapter 17, for example). The adapters thus configured require the use of no special tools, being hand mountable in the field by a test technician at both manifold body 21 and to the system lead.

While threaded engagement at manifold body 21 by the standardized tool mounting end 63 of the adapters is shown, any of a variety of other known mounting arrangements could be utilized so long as the interface is relatively fluid tight and capable of withstanding the applied pressures.

The variously configured threaded system adaptation ends 67 of different ones of the adapters of this invention differ from one another in any of their outside diameter sizes, thread orientations, thread sizes, or thread pitch. Configuration and outside diameter (OD) sizes of system adaptation ends 67, for example, may be provided to allow tool adaptation to any common swivel union size typically encountered in the field (for example, as illustrated herein, end 67 of adapter 13 can have an OD of 2″, end 67 of adapter 15 2.2″, and end 67 of adapter 17 2.45″, the tool mounting ends 63 of each having an outside diameter of about 1.25″ and with all three adapters configured for 0.12×1″ threads).

It should be appreciated that, where male and/or female threaded orientations of the various features of this invention are shown and described herein, the opposite thread orientations could be utilized. Moreover, while one thread orientation (male or female), thread size, thread spacing and thread pitch are illustrated for the variously configured system adaptation end of adapters of this invention, any selected thread orientation, size, spacing and/or pitch could be provided on different adapters in a particular adapter set.

As may be appreciated from the foregoing, this invention provides a universally adaptable gas system pressurization/leak testing tool. Selected adapter sets are included that allow tool adaptation to any of a wide variety of system leads that may be encountered by a test technician in the field.

What is claimed is:

1. A tool for accommodating pressurization of a facility gas supply system at system piping to test system integrity comprising:
a manifold body having a plurality of access openings in fluid communication with one another, one of said openings adapted for connection with a pressurized fluid source;
a gauge having a stem engageable at another of said access openings of said manifold body; and
plural interchangeable threaded system adapters selectively engageable at still another of said access openings.

2. The tool of claim 1 further comprising a valved fluid intake stem at said one of said access openings.

3. The tool of claim 1 further comprising a pressure relief valve mounted at a selected said access opening.

4. The tool of claim 3 wherein said relief valve is mounted at yet another of said access openings.

5. The tool of claim 1 wherein each of said interchangeable threaded system adapters include a standardized size end mountable at said still another of said access openings and a variously configured threaded system adaptation end.

6. The tool of claim 5 wherein each of said system adapters includes a central body portion configured for manual manipulation.

7. The tool of claim 1 wherein each of said system adapters is made of material substantially impervious to corrosion due to exposure to natural gas or liquefied propane.

8. A gas system adapter set for a leak detecting tool used to pressurize a commercial or residential gas supply system, said adapter set utilized to adapt the detecting tool for connection at threaded fittings of various sizes, orientations and/or configurations that connect facility gas systems to system leads, said adapter set comprising:
a first adapter including a central body portion between a tool mounting end and a selectively configured threaded system adaptation end; and
at least one additional adapter including a central body portion between a tool mounting end of substantially the same size and configuration as said tool mounting end of said first adapter and a selectively configured threaded system adaptation end differently configured from said selectively configured threaded system adaptation end of said first adapter.

9. The adapter set of claim 8 comprising at least three said adapters.

10. The adapter set of claim 8 wherein said selectively configured threaded system adaptation ends of said adapters are each characterized by any of different opening sizes, different thread orientations, different thread sizes, or different thread pitch.

11. The adapter set of claim 8 wherein said adapters each have a fluid passageway therethrough between said ends thereof.

12. The adapter set of claim 8 wherein said tool mounting ends of said adapters are threaded.

13. The adapter set of claim 8 wherein said central body portions of said adapters are substantially annular.

14. A universal leak detection tool for testing pressurization stability at commercial and/or residential gas supply system piping comprising:
a manifold body having at least first, second, third and forth threaded access openings in fluid communication with one another;
a valved fluid intake stem threadably engageable at said first access opening;
a pressure relief valve threadably engageable at said second access opening;
a pressure gauge having a threaded stem engageable at said third access opening; and
a plurality of adapters each including a manipulable central body portion between a size/configuration standardized threaded tool mounting end engageable at said forth access opening and a variously configured threaded system adaptation end.

15. The tool of claim 14 wherein said variously configured threaded system adaptation ends of said plurality of adapters have outside diameters and differ from one another in any of said outside diameter sizes, thread orientations, thread sizes, or thread pitch.

16. The tool of claim 14 wherein said fluid intake stem includes a threaded end adapted for connection with a pressurized fluid source.

17. The tool of claim 14 wherein said central body portions of said adapters are substantially annular to facilitate manual manipulation of said adapters.

18. The tool of claim 14 wherein said adapters are made of metal material characterized by substantial imperviousness to corrosion due to exposure to natural gas or liquefied propane.

19. The tool of claim 14 wherein said manifold body includes a fluid communication passageway between said first and second threaded access openings.

20. The tool of claim 19 wherein said manifold body includes first and second lateral passages extending between said fluid communication passageway and said third and forth threaded access openings, respectively.
